(19) United States
(12) Patent Application Publication
(10) Pub. No.: US 2026/0104098 A1
(43) Pub. Date: Apr. 16, 2026

(54) MULTI-WAY VALVE AND A HEAT PUMP SYSTEM INCLUDING THE SAME

(71) Applicants: HYUNDAI MOTOR COMPANY, Seoul (KR); KIA CORPORATION, Seoul (KR)

(72) Inventor: Seong-Bin Jeong, Seongnam-si (KR)

(73) Assignees: HYUNDAI MOTOR COMPANY, Seoul (KR); KIA CORPORATION, Seoul (KR)

(21) Appl. No.: 19/420,267

(22) Filed: Dec. 15, 2025

Related U.S. Application Data
(62) Division of application No. 18/657,252, filed on May 7, 2024.

(30) Foreign Application Priority Data
Dec. 4, 2023 (KR) 10-2023-0173099

(51) Int. Cl. F16K 11/087; F25B 41/26

(52) U.S. Cl. CPC F16K 11/0876; F25B 41/26

(57) ABSTRACT

A heat pump system includes a multi-way valve. The multi-way valve includes a valve housing including a plurality of inlets/outlets formed along a circumference of the valve housing, an open lower portion, and a first connection flow path rotatably provided inside the valve housing. The multi-way valve further includes a valve body in which a second connection flow path is formed. The heat pump system further includes: a driver configured to selectively rotate the valve body; a first refrigerant line disposed below the valve housing and through which a refrigerant flows; and a second refrigerant line, a third refrigerant line, a fourth refrigerant line and a fifth refrigerant line, which are arranged to be spaced apart from each other sequentially at a set angle along a circumference of the multi-way valve.

### CROSS-REFERENCE TO RELATED APPLICATION

This application is a divisional application of non-provisional U.S. patent application Ser. No. 18/657,252, filed on May 7, 2024, which claims priority to and the benefit of Korean Patent Application No. 10-2023-0173099, filed in the Korean Intellectual Property Office on Dec. 4, 2023, the entire contents of each off which are incorporated herein by reference.

### BACKGROUND

### (a) Field

The present disclosure relates to a multi-way valve and a heat pump system including the same and, more particularly, to a multi-way valve capable of forming a plurality of refrigerant flow paths through a simple configuration and a heat pump system including the same.

### (b) Description of the Related Art

In general, air-conditioning systems for automobiles include an air-conditioning device that circulates a refrigerant to heat or cool the interior of automobiles.

The air-conditioning device maintains the temperature inside a vehicle at an appropriate temperature, regardless of external temperature changes, to maintain a comfortable indoor environment. The air-conditioning device is configured to heat or cool the interior of a vehicle by exchanging heat by an evaporator in a process in which a refrigerant discharged according to driving of a compressor circulates through a condenser, a receiver dryer, an expansion valve, an evaporator, and then back to the compressor.

In other words, in a cooling mode in the summer, the high-temperature, high-pressure gaseous refrigerant compressed by the compressor is condensed through the condenser, passes through the receiver dryer and the expansion valve, and evaporates in the evaporator to lower an indoor temperature and humidity.

Meanwhile, as interest in energy efficiency and environmental pollution issues has recently grown day by day, there is demand for the development of eco-friendly vehicles that may substantially replace internal combustion engine vehicles, and such eco-friendly vehicles are usually classified into electric vehicles that are driven by battery power as a power source and hybrid vehicles that are driven by an engine and a battery.

Among these eco-friendly vehicles, electric vehicles or hybrid vehicles do not use a separate heater, unlike the air-conditioning system of regular vehicles, and an air-conditioning device applied to eco-friendly vehicles is usually referred to as a heat pump system.

In the case of an electric vehicle, a driving motor generates driving force necessary for driving the vehicle through power of a battery. Because heat is generated by the battery and the driving motor in this process, it is essential to effectively remove heat generated by the battery and the driving motor to ensure the performance of the battery and the driving motor.

In addition, in hybrid vehicles, driving force is generated by a driving motor using electricity supplied from a battery, together with an engine operated by general fuel, and here, heat generated by a fuel cell, a battery, or a motor should be effectively removed to ensure performance of the motor.

The above information disclosed in this background section is provided only to enhance understanding of the background of the present disclosure, and therefore it may contain information that does not form the prior art that is already known to a person of ordinary skill in the art.

### SUMMARY

The present disclosure provides a multi-way refrigerant valve and a heat pump system including the same, capable of simplifying a layout of a heat pump system and reducing manufacturing costs by forming a plurality of refrigerant flow paths through one valve.

The present disclosure also provides a multi-way refrigerant valve capable of forming a plurality of refrigerant flow paths, according to a selected mode of a vehicle, in a refrigerant valve through simple control, and a heat pump system including the same.

According to an embodiment, a multi-way valve includes: a valve housing including a plurality of inlets/outlets formed along a circumference of the valve housing and an open lower portion. The multi-way valve further includes; a valve body rotatably provided inside the valve housing and including a plurality of connection flow paths configured to selectively and fluidly connect the plurality of inlets/outlets; and a driver configured to selectively rotate the valve body.

In an embodiment, the valve housing may include a lower housing having a mounting space in which the valve body is provided therein, and the plurality of inlets/outlets are formed in the lower housing. The valve housing may include an upper housing provided above the lower housing and the driver is disposed on the upper housing.

In some embodiments, the plurality of inlets/outlets may include first to fourth inlets/outlets formed at equal intervals along a circumference of the lower housing.

In some embodiments, a limiter may be formed in the upper housing.

In some embodiments, the valve body may be formed in a spherical shape, and the plurality of connection flow paths may include a first connection flow path formed in a direction from a lower portion of a center of the valve body toward a radially outer side of the valve body and a second connection flow path formed in a direction facing a circumferential direction based on a rotation axis of the valve body.

In some embodiments, the first connection flow path may be formed to fluidly connect a first opening formed in a lower portion of the center of the valve body and a second opening formed on a side surface of the valve body.

In some embodiments, the second connection flow path may be formed to fluidly connect a third opening formed to be spaced apart from the second opening of the valve body at a set angle and a fourth opening formed to be spaced apart from the third opening at a set angle.

In some embodiments, the multi-way valve may further include: a valve seat provided at the plurality of inlets/outlets of the valve housing and configured to rotatably support the valve body.

In some embodiments, a support surface of the valve seat facing the valve body may be formed in a partially spherical shape corresponding to the valve body.

In some embodiments, the multi-way valve may further include: a cap cover provided on a radially outer side of the valve seat and configured to prevent separation of the valve body.

In some embodiments, the multi-way valve may further include: a first O-ring provided on the valve seat; and a second O-ring provided on the cap cover.

In some embodiments, the driver may include: a driving gear on which a stop protrusion is formed; and a driving shaft configured to rotate integrally with the driving gear and coupled to the valve body. In particular, the stop protrusion may selectively contact a limiter formed in an upper portion of the valve housing to selectively limit rotation of the driving gear.

In some embodiments, the multi-way valve may further include: a gasket provided on the outside of the valve housing.

According to another embodiment, a heat pump system includes: a multi-way valve including a valve housing having first to fourth inlets/outlets formed along a circumference of the valve housing and an open lower portion, a first connection flow path rotatably provided inside the valve housing and selectively fluidly connected to at least one of the first to fourth inlets/outlets, a valve body in which a second connection flow path is formed, and a driver configured to selectively rotate the valve body; a first refrigerant line disposed below the valve housing and through which a refrigerant flows; and second to fifth refrigerant lines arranged to be spaced apart from each other sequentially at a set angle along a circumference of the multi-way valve and through which the refrigerant flows. In particular, the multi-way valve selectively operates in a first mode, a second mode, or a third mode according to the rotation of the valve body. In one embodiment, a first side of the first connection flow path is constantly fluidly connected to the first refrigerant line, the other side of the first connection flow path is selectively fluidly connected to the second refrigerant line, the third refrigerant line, or the fifth refrigerant line, one side of the second connection flow path is selectively fluidly connected to the second refrigerant line, the fourth refrigerant line, or the fifth refrigerant line, and the other side of the second connection flow path is selectively fluidly connected to the third refrigerant line, the fourth refrigerant line, or the fifth refrigerant line.

In some embodiments, in the first mode in which the valve body is located in a reference position, the first refrigerant line and the fifth refrigerant line may be fluidly connected through the first connection flow path, and the third refrigerant line and the fourth refrigerant line may be fluidly connected through the second connection flow path.

In some embodiments, in the second mode in which the valve body rotates by a first set angle from the reference position in a set direction, the first refrigerant line and the second refrigerant line may be fluidly connected through the first connection flow path, and the fourth refrigerant line and the fifth refrigerant line may be fluidly connected through the second connection flow path.

In some embodiments, in the third mode in which the valve body rotates by a second set angle from the reference position in a set direction, the first refrigerant line and the third refrigerant line may be fluidly connected through the first connection flow path, and the second refrigerant line and the fifth refrigerant line may be fluidly connected through the second connection flow path.

According to some embodiments, by providing a multi-way valve in a plurality of refrigerant flow paths through which a refrigerant flows, the number of refrigerant valves applied to the related art heat pump system may be minimized and the heat pump system may be simplified.

In addition, effects that may be obtained or expected due to embodiments of the present disclosure should be directly or implicitly disclosed in the detailed description of the disclosure.

### BRIEF DESCRIPTION OF THE DRAWINGS

The drawings are used to be referred to in describing some embodiments of the present disclosure, so a technical concept of the disclosure should not be meant to restrict the present disclosure to the accompanying drawings.

FIG. 1 is a perspective view illustrating a configuration of a multi-way valve according to an embodiment.

FIG. 2 is an exploded perspective view illustrating a configuration of a multi-way valve according to an embodiment.

FIGS. 3 and 4 are perspective views illustrating a configuration of a valve housing according to an embodiment.

FIGS. 5 and 6 are perspective views illustrating a configuration of a valve body according to an embodiment.

FIGS. 7 and 8 are cross-sectional views illustrating a configuration of a valve body according to an embodiment.

FIGS. 9 and 10 are perspective views illustrating a configuration of a valve seat according to an embodiment.

FIG. 11 is a perspective view illustrating a configuration of a cap cover according to an embodiment.

FIGS. 12A-12C are diagrams illustrating an operating state of a multi-way valve according to an embodiment.

It is to be understood that the drawings referenced above are not necessarily drawn to scale, but rather present a rather simplified representation of various features illustrating the basic principles of the present disclosure. Certain design features of the disclosure, including, for example, particular dimensions, orientation, location, and shape, should be determined in part by the particular intended application and environment of use.

### DETAILED DESCRIPTION

The terminology used herein is for the purpose of describing specific embodiments only and is not intended to limit the present disclosure. As used herein, the singular forms are intended to include the plural forms as well, unless the context clearly indicates otherwise. The terms “comprise” and/or “comprising”, when used herein, specify the presence of recited features, integers, levels, operations, components and/or components, but it should also be understood that does not exclude the presence or addition of one or more of the features, integers, levels, acts, elements, components and/or groups thereof. As used herein, the term “and/or” includes any one or all combinations of the associated listed items.

Some embodiments of the present disclosure are described in detail with reference to the accompanying drawings to allow those having ordinary skill in the art to easily practice the present disclosure. However, the present disclosure may be implemented in various different forms and is not limited to the embodiments as described herein.

Portions unrelated to the description may be omitted in order to more clearly describe the present disclosure, and the same or similar components may be denoted by the same reference numerals throughout the present specification.

The size and thickness of each component shown in the drawings may be arbitrarily shown for convenience of explanation, and therefore, the disclosure is not necessarily limited to the shown exemplary embodiments in the drawings, and the thickness of various portions and regions are enlarged for clarity.

In addition, terms “module” and/or “portion” for components used in the present specification are used only in order to easily make the specification. Therefore, these terms do not have meanings or roles that are distinguished from each other. When a component, device, element, or the like of the present disclosure is described as having a purpose or performing an operation, function, or the like, the component, device, or element should be considered herein as being “configured to”meet that purpose or to perform that operation or function.

In describing the embodiments, when a detailed description of the relevant known function or configuration is determined to unnecessarily obscure the important point of the disclosure, the detailed description has been omitted.

The accompanying drawings of the disclosure aim to facilitate understanding of the disclosure and should not be construed as limited to the accompanying drawings. Also, the disclosure is not limited to a specific disclosed form but includes all modifications, equivalents, and substitutions without departing from the scope and spirit of the disclosure.

Terms including ordinals, such as first, second, etc., may be used to describe various elements but such elements are not limited to the above terms.

In the description below, expressions described as singular may be interpreted as singular or plural, unless explicit expressions, such as “one” or “single”are used.

The above terms are used only for the purpose of distinguishing one component from another.

Hereinafter, a multi-way valve according to an embodiment is described in detail with reference to the attached drawings.

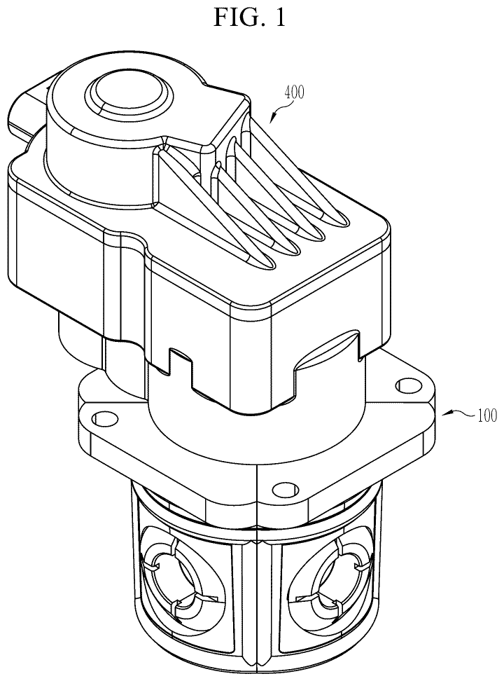

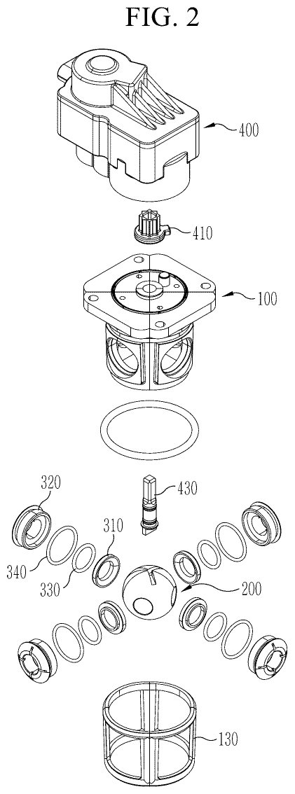

FIG. 1 is a perspective view illustrating a configuration of a multi-way valve according to an embodiment. Also, FIG. 2 is an exploded perspective view illustrating a configuration of a multi-way valve according to an embodiment.

As shown in FIGS. 1 and 2, the multi-flow path valve according to an embodiment includes a valve housing 100 including a plurality of inlets and outlets formed along the circumference of the valve housing, and an open lower portion. The multi-flow path valve further includes: a valve body 200 rotatably provided inside the valve housing 100; and a driver 400 selectively rotating the valve body 200.

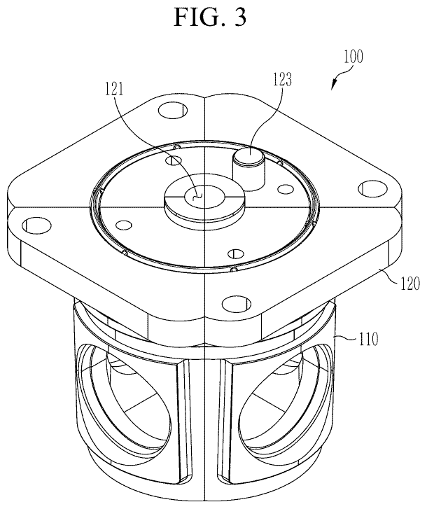

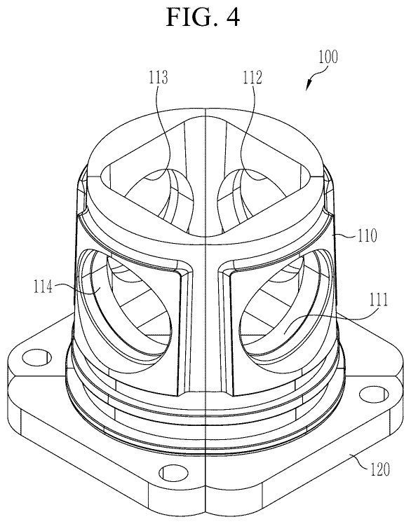

Referring to FIGS. 3 and 4, the valve housing 100 may include: a lower housing 110, and an upper housing 120 provided on top of the lower housing 110.

The lower housing 110 may include: a mounting space in which the valve body 200 is installed, a lower portion that may be open, and a plurality of inlets/outlets that may be formed along the circumference of the lower housing 110. The lower housing 110 may be formed in a substantially square block shape or a cylindrical shape.

The plurality of inlets/outlets may include first to fourth inlets/outlets (111, 112, 113 and 114) formed at equal intervals along the circumference of the lower housing 110. For example, the first inlet/outlet 111 to the fourth inlet/outlet 114 may be formed at 90-degree intervals along the circumference of the lower housing 110.

The upper housing 120 is mounted on top of the lower housing 110 and may be formed in a substantially plate shape. The driver 400 may be mounted on the upper housing 120. A mounting hole 121 may be formed in the center of the upper housing 120, and a driving shaft 430, which is described below, may be rotatably mounted on the mounting hole 121.

In an embodiment, a limiter 123 may be formed to protrude from the upper housing 120. The limiter 123 may be formed to be spaced apart from a through-hole of the upper housing 120 by a certain distance. In other words, the limiter 123 may be formed at a position eccentric from the through-hole. The limiter 123 may limit a rotation angle of a driving gear 410 of the driver 400, which is described below.

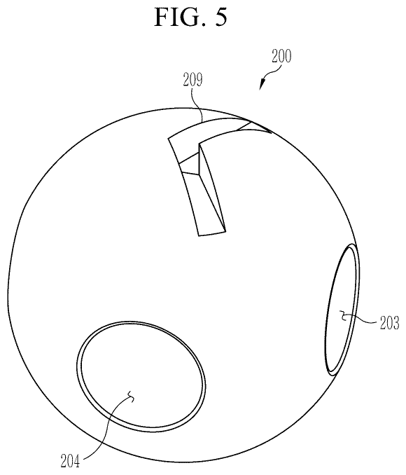

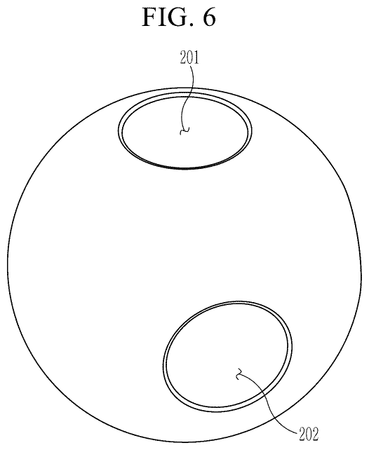

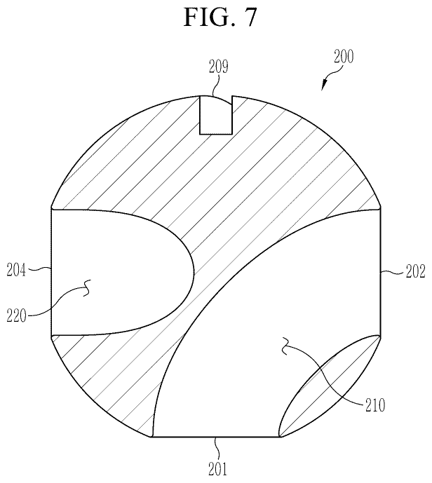

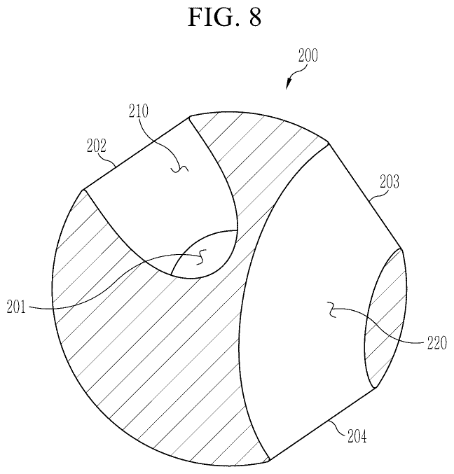

FIGS. 5 and 6 are perspective views illustrating the configuration of the valve body 200 according to an embodiment. FIGS. 7 and 8 are cross-sectional views illustrating a configuration of the valve body 200 according to an embodiment.

Referring to FIGS. 5 to 8, the valve body 200 may be rotatably mounted in the mounting space of the valve housing 100 and may have a plurality of connection flow paths selectively and fluidly connected to the plurality of inlets/outlets of the valve housing 100. Also, a coupling groove 209 may be formed in the center of an upper portion of the valve body 200.

The valve body 200 is formed in a spherical shape, and the plurality of connection flow paths may include: a first connection flow path 210 formed in a direction from a lower portion of the center of the valve body 200 toward a radially outer side of the valve body 200, and a second connection flow path 220 formed in a direction facing a circumferential direction based on a rotation axis 230 of the valve body 200.

For example, a first opening 201 may be formed in the center of a lower portion of the valve body 200. A second opening 202, a third opening 203, and a fourth opening 204 may be formed on a side surface of the valve body 200 and spaced apart from each other at a set angle in the circumferential direction. In one form, the second opening 202 and the third opening 203 may be formed to be spaced apart from each other by 90 degrees in the circumferential direction, and the third opening 203 and the fourth opening 204 may be formed to be spaced apart from each other by 90 degrees in the circumferential direction. The first connection flow path 210 may be formed to fluidly connect the first opening 201 to the second opening 202, and the second connection flow path 220 may be formed to fluidly connect the third opening 203 to the fourth opening 204. At this time, one end (e.g., the first opening 201) of the first connection flow path 210 may be formed to face in the direction of gravity.

The valve body 200 may be formed of a material that blocks heat transfer such that the valve body 20 may prevent the exchange of heat between fluids (e.g., refrigerants) that flow along the first connection flow path 210 and the second connection flow path 220. For example, the valve body 200 may be formed of an insulating material. As the valve body 200 is formed of the insulating material, heat exchange between a high-temperature fluid flowing through the first connection flow path 210 and a low-temperature fluid flowing along the second connection flow path 220 may be minimized. Through this, the overall performance of the heat pump system 500 may be prevented from being deteriorated, and the efficiency of the heat pump system 500 may be improved.

Referring back to FIGS. 1 and 2, a valve seat 310 may be provided at each of the plurality of inlets/outlets of the valve housing 100. The valve seat 310 may rotatably support the valve body 200. In addition, a cap cover 320 may be provided on a radial outer side of the valve seat 310 to prevent the valve body 200 from being separated.

In addition, a gasket 130 may be provided on the outside of the valve housing 100. When the multi-way valve is installed in a refrigerant line of the heat pump system 500, the fluid flowing in the refrigerant line may be prevented from leaking to the outside.

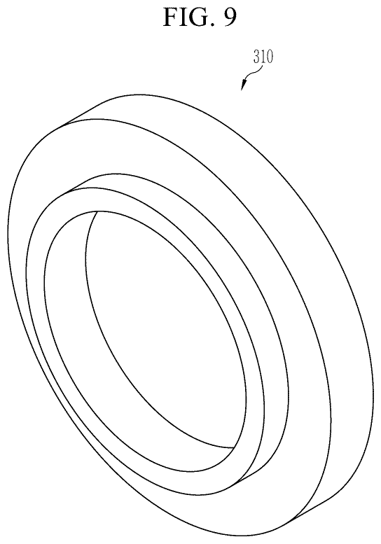

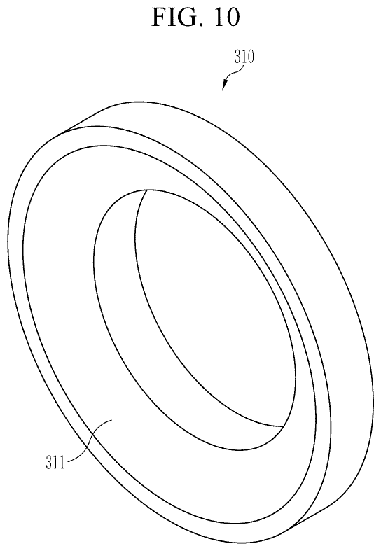

Referring to FIGS. 9 and 10, the valve seat 310 may be formed in a substantially ring shape, and a support surface 311 facing the valve body 200 may be formed in a partially spherical shape corresponding to the valve body 200. The valve seat 310 may serve as a type of bearing that supports rotation of the valve body 200.

Referring back to FIGS. 1 and 2, the cap cover 320 may be formed in a substantially ring shape and may be installed at each inlet/outlet of the valve housing 100 to prevent the valve body 200 from separating from the valve housing 100.

In another embodiment, a first O-ring 330 may be provided between the valve seat 310 and the cap cover 320, and a second O-ring 340 may be provided between the cap cover 320 and the inlet/outlet. The first O-ring 330 and the second O-ring 340 may prevent fluid flowing through the valve body 200 and the valve housing 100 from leaking to the outside.

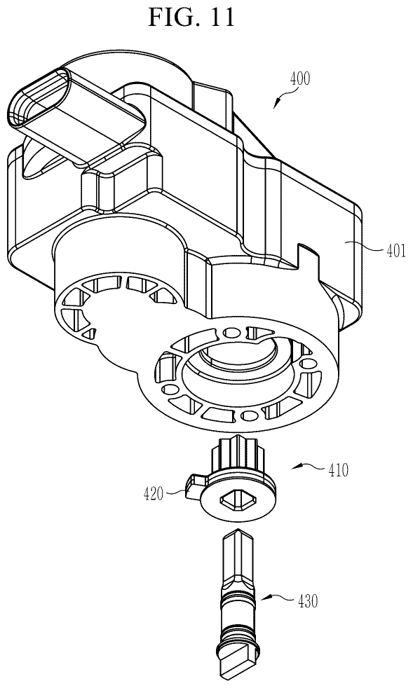

Referring to FIG. 11, the driver 400 may include a driving gear 410 and a driving shaft 430 that is integrally coupled with the driving gear 410 and rotates.

The driving gear 410 rotates by power transmitted from a power source 401 (e.g., an electric motor, a step motor, or a solenoid, etc.), and a stop protrusion 420 may be formed on a radially outer side of the driving gear 410. The driving gear 410, the driving shaft 430, and the valve body 200 may rotate at a set angle (e.g., 90 degrees) by the power source 401.

One end (e.g., an upper end) of the driving shaft 430 may be integrally coupled to the driving gear 410, and the other end (e.g., a lower end) may be coupled to an upper portion of the valve body 200. One end of the driving shaft 430 may be press-fitted and fixedly coupled to the driving gear 410, and the other end of the driving shaft 430 may be inserted into and coupled to the coupling groove 209 formed in the center of the upper portion of the valve body 200. The driving shaft 430 may be coupled to the valve housing 100 by penetrating through the mounting hole 121 formed in the upper housing 120 of the valve housing 100.

As the driving gear 410 rotates, the driving shaft 430 rotates, and when the driving shaft 430 rotates, the valve body 200 rotates.

The stop protrusion 420 formed on the driving gear 410 selectively contacts the limiter 123 formed in the upper housing 120 of the valve housing 100 and may limit rotation of the driving gear 410. By the stop protrusion 420 and the limiter 123, the driving gear 410 may rotate 360 degrees in one direction (e.g., clockwise) and 360 degrees in the other direction (e.g., counterclockwise).

Hereinafter, the operation of the multi-way valve according to an embodiment is described in detail with reference to the attached drawings.

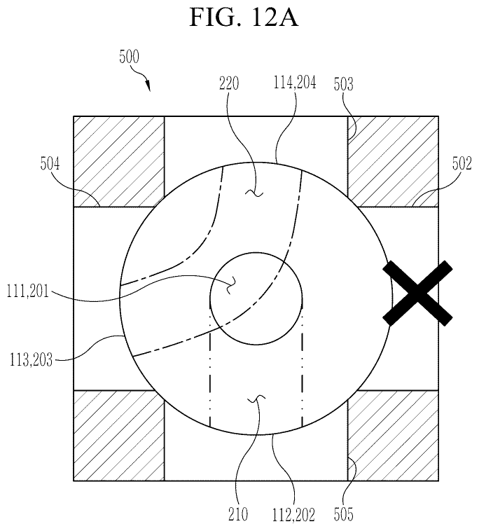

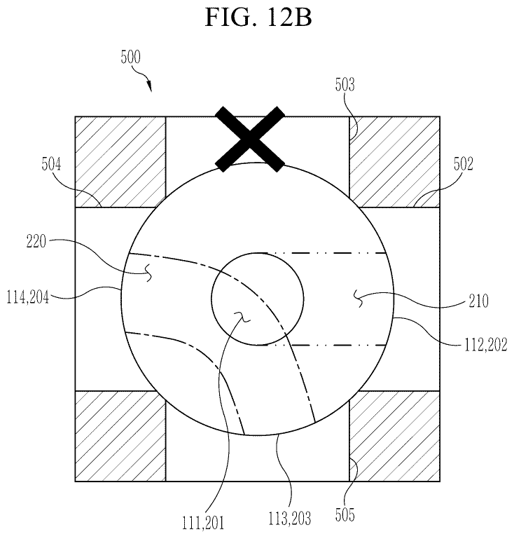

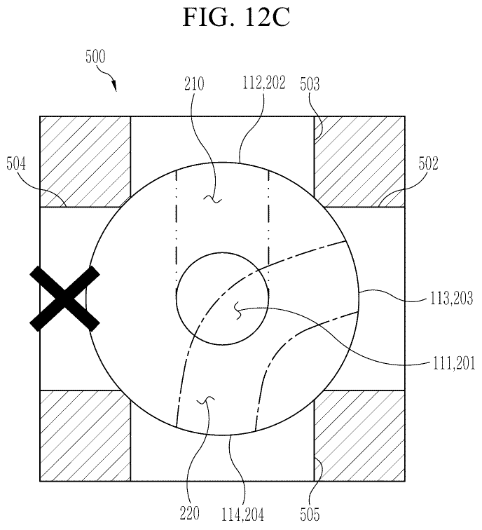

FIG. 12 is a diagram illustrating an operating state of a multi-way valve according to an embodiment.

Referring to FIG. 12, the multi-way valve may selectively operate in a first mode, a second mode, or a third mode, depending on an operation mode of the heat pump system 500.

The heat pump system 500 may include a plurality of refrigerant lines through which a refrigerant flows. For example, the plurality of refrigerant lines may include five refrigerant lines, e.g., a first refrigerant line 501 to a fifth refrigerant line 505.

The first refrigerant line 501 may be disposed in a lower portion of the valve housing 100 of the multi-way valve. The first refrigerant line 501 may be constantly fluidly connected to the first opening 201.

In one embodiment, the second refrigerant line 502 to the fifth refrigerant line 505 may be sequentially arranged at a set angle (e.g., 90 degrees) apart from each other along the circumference of the rotation axis 230 of the multi-way valve, and the second refrigerant lines 502 to the fifth refrigerant lines 505 may be selectively fluidly connected to the second openings 202 to fourth openings 204.

In other words, as the valve body 200 rotates, one side (the first opening 201 and the first inlet/outlet 111) of the first connection flow path 210 may be constantly fluidly connected to the first refrigerant line 501, and the other side (the second opening 202 and the second inlet/outlet 112) of the first connection flow path 210 may be selectively fluidly connected to the second refrigerant line 502, the third refrigerant line 503, or the fifth refrigerant line 505. Also, one side (the third opening 203 and the third inlet/outlet 113) of the second connection flow path 220 may be selectively fluidly connected to the second refrigerant line 502, the fourth refrigerant line 504, or the fifth refrigerant line 505, and the other side (the fourth opening 204 and the fourth inlet/outlet 114) of the second connection flow path 220 may be selectively fluidly connected to the third refrigerant line 503, the fourth refrigerant line 504, or the fifth refrigerant line 505.

The first mode may refer to a state in which the valve body 200 is located in a reference position, the second mode may refer to a case in which the valve body 200 has been rotated at a first set angle (e.g., 90 degrees) in a set direction (e.g., counterclockwise) from the reference position, and the third mode may refer to a state in which when the valve body 200 has been rotated at a second set angle (e.g., 180 degrees) in a set direction (e.g., counterclockwise) from the reference position.

Referring to FIG. 12A, in the first mode in which the valve body 200 is located at the reference position, the first opening 201 and the first inlet/outlet 111 may be fluidly connected to the first refrigerant line 501, the second opening 202 and the second inlet/outlet 112 may be fluidly connected to the fifth refrigerant line 505, the third opening 203 and the third inlet/outlet 113 may be fluidly connected to the fourth refrigerant line 504, and the fourth opening 204 and the fourth inlet/outlet 114 may be fluidly connected to the third refrigerant line 503, and the second refrigerant line 502 may be blocked.

In other words, in the first mode, the first refrigerant line 501 and the fifth refrigerant line 505 may be fluidly connected through the first connection flow path 210, and the third refrigerant line 503 and the fourth refrigerant line 504 may be fluidly connected through the second connection flow path 220.

Accordingly, the refrigerant flowing into the first refrigerant line 501 may be discharged to the fifth refrigerant line 505 through the first connection flow path 210, and the refrigerant flowing into the fourth refrigerant line 504 may be discharged to the third refrigerant line 503 through the second connection flow path 220. Alternatively, the refrigerant flowing into the fifth refrigerant line 505 may be discharged to the first refrigerant line 501 through the first connection flow path 210, and the refrigerant flowing into the third refrigerant line 503 may be discharged the fourth refrigerant line 504 through the second connection flow path 220.

Referring to FIG. 12B, in the second mode in which the valve body 200 has been rotated by 90 degrees counterclockwise from the reference position, the first opening 201 and the first inlet/outlet 111 may be fluidly connected to the first refrigerant line 501, the second opening 202 and the second inlet/outlet 112 may be fluidly connected to the second refrigerant line 502, the third opening 203 and the third inlet/outlet 113 may be fluidly connected to the fifth refrigerant line 505, the fourth opening 204 and the fourth inlet/outlet 114 may be fluidly connected to the fourth refrigerant line 504, and the third refrigerant line 503 may be blocked.

In other words, in the second mode, the first refrigerant line 501 and the second refrigerant line 502 may be fluidly connected through the first connection flow path 210, and the fourth refrigerant line 504 and the fifth refrigerant line 505 may be fluidly connected through the second connection flow path 220.

Accordingly, the refrigerant flowing into the first refrigerant line 501 may be discharged to the second refrigerant line 502 through the first connection flow path 210, and the refrigerant flowing into the fifth refrigerant line 505 may be discharged to the fourth refrigerant line 504 through the second connection flow path 220. Alternatively, the refrigerant flowing into the second refrigerant line 502 may be discharged to the first refrigerant line 501 through the first connection flow path 210, and the refrigerant flowing into the fourth refrigerant line 504 may be discharged to the fifth refrigerant line 505 through the second connection flow path 220.

Referring to FIG. 12C, in the third mode in which the valve body 200 has been rotated by 180 degrees counterclockwise from the reference position, the first opening 201 and the first inlet/outlet 111 may be fluidly connected to the first refrigerant line 501, the second opening 202 and the second inlet/outlet 112 may be fluidly connected to the third refrigerant line 503, the third opening 203 and the third inlet/outlet 113 may be fluidly connected to the second refrigerant line 502, and the fourth opening 204 and the fourth inlet/outlet 114 may be fluidly connected to the fifth refrigerant line 505, and the fourth refrigerant line 504 may be blocked.

In other words, in the third mode, the first refrigerant line 501 and the third refrigerant line 503 may be fluidly connected through the first connection flow path 210, and the second refrigerant line 502 and the fifth refrigerant line 505 may be fluidly connected through the second connection flow path 220.

Accordingly, the refrigerant flowing into the first refrigerant line 501 may be discharged to the third refrigerant line 503 through the first connection flow path 210, the refrigerant flowing into the second refrigerant line 502 may be discharged to the fifth refrigerant line 505 through the second connection flow path 220. Alternatively, the refrigerant flowing from the third refrigerant line 503 may be discharged to the first refrigerant line 501 through the first connection flow path 210, and the refrigerant flowing from the fifth refrigerant line 505 may be discharged to the second refrigerant line 502 through the second connection flow path 220.

According to the multi-way valve and the heat pump system 500 including the same according to an embodiment, by providing the multi-way valve in a plurality of refrigerant flow paths through which a refrigerant flows, the number of refrigerant valves applied to the related art heat pump system may be minimized and the heat pump system may be simplified.

In addition, according to the disclosure, since one or a plurality of refrigerant flow paths are formed as the valve body 200 rotates at a set angle by the driver 400 inside the valve housing, valve control may be facilitated.

In addition, by simplifying the overall heat pump system 500, manufacturing costs may be reduced, weight may be reduced, and space utilization may be improved.

Although the some embodiment of the present disclosure have been described above, the present disclosure is not limited thereto, and it is possible to carry out various modifications within the claim coverage, the description of the present disclosure, and the accompanying drawings, and such modifications also fall within the scope of the present disclosure.

### DESCRIPTION OF SYMBOLS

100: valve housing
110: lower housing
111: first inlet/outlet
112: second inlet/outlet
113: third inlet/outlet
114: fourth inlet/outlet
120: upper housing
121: mounting hole
123: limiter
130: gasket
200: valve body
201: first opening
202: second opening
203: third opening
204: fourth opening
209: coupling groove
210: first connection flow path
220: second connection flow path
230: rotation axis
310: valve seat
311: support surface
320: cap cover
330: first O-ring
340: second O-ring
400: driver
401: power source
410: driving gear
420: stop protrusion
430: driving shaft
500: heat pump system
501: first refrigerant line
502: second refrigerant line
503: third refrigerant line
504: fourth refrigerant line
505: fifth refrigerant line

What is claimed is:

1. A heat pump system comprising:
a multi-way valve including:
a valve housing including:
a first inlet/outlet, a second inlet/outlet, a third inlet/outlet and a fourth inlet/outlet, which are formed along a circumference of the valve housing;
an open lower portion;
a first connection flow path rotatably provided inside the valve housing and selectively fluidly connected to at least one of the first to fourth inlets/outlets;
a valve body in which a second connection flow path is formed; and
a driver configured to selectively rotate the valve body;
a first refrigerant line disposed below the valve housing and through which a refrigerant flows; and
a second refrigerant line, a third refrigerant line, a fourth refrigerant line and a fifth refrigerant line, which are arranged to be spaced apart from each other sequentially at a set angle along a circumference of the multi-way valve and through which the refrigerant flows,
wherein:
the multi-way valve is configured to selectively operate in a first mode, a second mode or a third mode, according to the rotation of the valve body,
a first side of the first connection flow path is constantly fluidly connected to the first refrigerant line,
a second side of the first connection flow path is selectively fluidly connected to the second refrigerant line, the third refrigerant line, or the fifth refrigerant line,
a first side of the second connection flow path is selectively fluidly connected to the second refrigerant line, the fourth refrigerant line, or the fifth refrigerant line, and
a second side of the second connection flow path is selectively fluidly connected to the third refrigerant line, the fourth refrigerant line, or the fifth refrigerant line.

2. The heat pump system of claim 1, wherein in the first mode in which the valve body is located in a reference position,
the first refrigerant line and the fifth refrigerant line are fluidly connected through the first connection flow path, and
the third refrigerant line and the fourth refrigerant line are fluidly connected through the second connection flow path.

3. The heat pump system of claim 2, wherein in the second mode in which the valve body rotates by a first set angle from the reference position in a set direction,
the first refrigerant line and the second refrigerant line are fluidly connected through the first connection flow path, and
the fourth refrigerant line and the fifth refrigerant line are fluidly connected through the second connection flow path.

4. The heat pump system of claim 2, wherein in the third mode in which the valve body rotates by a second set angle from the reference position in a set direction,
the first refrigerant line and the third refrigerant line are fluidly connected through the first connection flow path, and
the second refrigerant line and the fifth refrigerant line are fluidly connected through the second connection flow path.
